(19) United States
(12) Patent Application Publication
(10) Pub. No.: US 2026/0231010 A1
(43) Pub. Date: Aug. 6, 2026

(54) MECHANISMS FOR HOSTING NETWORK SELECTION

(71) Applicant: Interdigital Patent Holdings, Inc., Wilmington, DE (US)

(72) Inventors: Anuj SETHI, Ottawa (CA); Guanzhou WANG, Brossard (CA); Zhibi WANG, Woodridge, IL (US); Michael STARSINIC, Newton, PA (US)

(73) Assignee: Interdigital Patent Holdings, Inc., Wilmington, DE (US)

(21) Appl. No.: 19/149,455

(22) PCT Filed: Feb. 9, 2024
(86) PCT No.: PCT/US2024/015140

§ 371 Date: Jul. 18, 2025

Related U.S. Application Data
(60) Provisional application No. 63/444,390, filed on Feb. 9, 2023.

(51) Int. Cl. H04W 48/18; H04W 48/16

(52) U.S. Cl. CPC H04W 48/18; H04W 48/16

(57) ABSTRACT

A wireless transmit/receive unit (WTRU) may trigger a search for a hosting network based on one or more of a request from a user for localized service, a periodic search, a loss of coverage, or meeting one or more validity conditions of the localized service. The WTRU may select one of a closed access group (CAG) or a stand-alone non-public network (SNPN) based on one or more of a universal subscriber identity module (USIM) elementary file, a user preference in local non-volatile memory (NVM) storage, a last searched technology, a power-up sequence preference, a value provided by a network, or a WTRU camped status. The WTRU may register with the CAG or SNPN based on the selection of the CAG or SNPN. One or more of the USIM elementary file, the power-up sequence preference, or the value provided by the network may be received by the WTRU in configuration in-(HNSM) formation.

### CROSS-REFERENCE TO RELATED APPLICATIONS

This application claims the benefit of U.S. Provisional Application No. 63/444,390, filed Feb. 9, 2023, the contents of which are incorporated herein by reference.

### BACKGROUND

A Non-Public Network (NPN) is a Fifth Generation of Mobile Telephone System (5GS) deployed for non-public use. An NPN may be either a Stand-alone Non-Public Network (SNPN) or a Public Network Integrated NPN (PNI-NPN).

An SNPN is operated by an NPN operator and does not rely on network functions provided by a public land mobile network (PLMN). A PNI-NPN is a non-public network deployed with the support of a PLMN.

### SUMMARY

A wireless transmit/receive unit (WTRU) may trigger a search for a hosting network based on one or more of a request from a user for localized service, a periodic search, a loss of coverage, or meeting one or more validity conditions of the localized service. The WTRU may select one of a closed access group (CAG) or a stand-alone non-public network (SNPN) based on one or more of a universal subscriber identity module (USIM) elementary file, a user preference in local non-volatile memory (NVM) storage, a last searched technology, a power-up sequence preference, a value provided by a network, or a WTRU camped status. The WTRU may register with the selected CAG or SNPN based on the selection of the CAG or SNPN.

In another example, one or more of the USIM elementary file, the power-up sequence preference, or the value provided by the network may be received by the WTRU in configuration information. In an additional example, the network may be a home public land mobile network (PLMN) (HPLMN), a visiting PLMN (VPLMN), or a credential holder (CH).

In a further example, one or more of the USIM elementary file, the user preference in local NVM storage, the last searched technology, or the power-up sequence preference, includes a preference for the CAG or the SNPN. In another example, the WTRU camped status may include a PLMN status or an SNPN status. Also, the loss of coverage may include an out of coverage scenario. In an additional example, the user preference may be received by way of a manual request for localized services by a user. Moreover, a validity condition may include one or more of a time condition, a location condition or a duration condition, in an example.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a flow chart diagram illustrating an example of an automatic mode of operation for hosting network selection;

FIG. 3 is a flow chart diagram illustrating an example of a method of operation for hosting network selection;

FIG. 4 is a flow chart diagram illustrating an example of a close access group (CAG) and Stand-alone Non-Public Network (SNPN) selection procedure; and

FIG. 5 is a flow chart diagram illustrating an example of a manual hosting network search and selection procedure.

### DETAILED DESCRIPTION

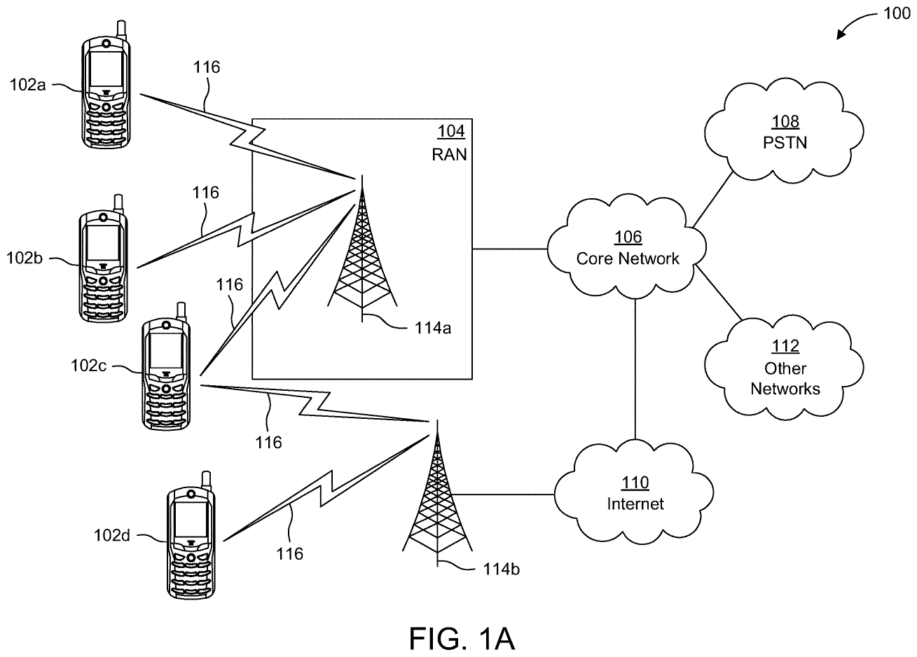

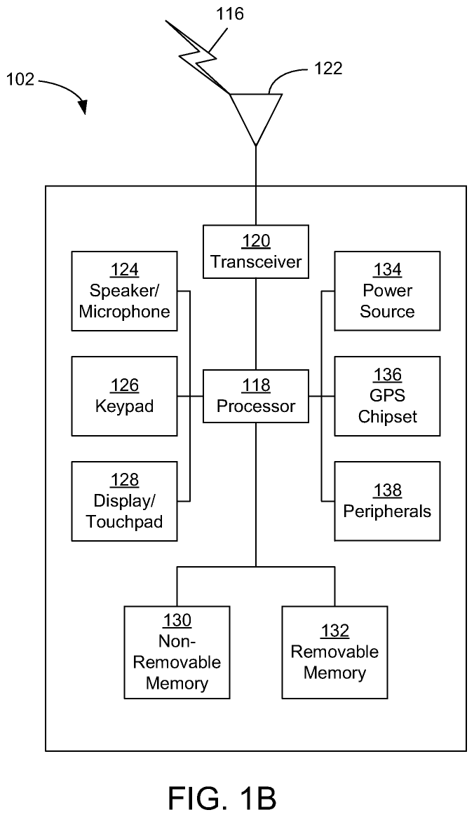

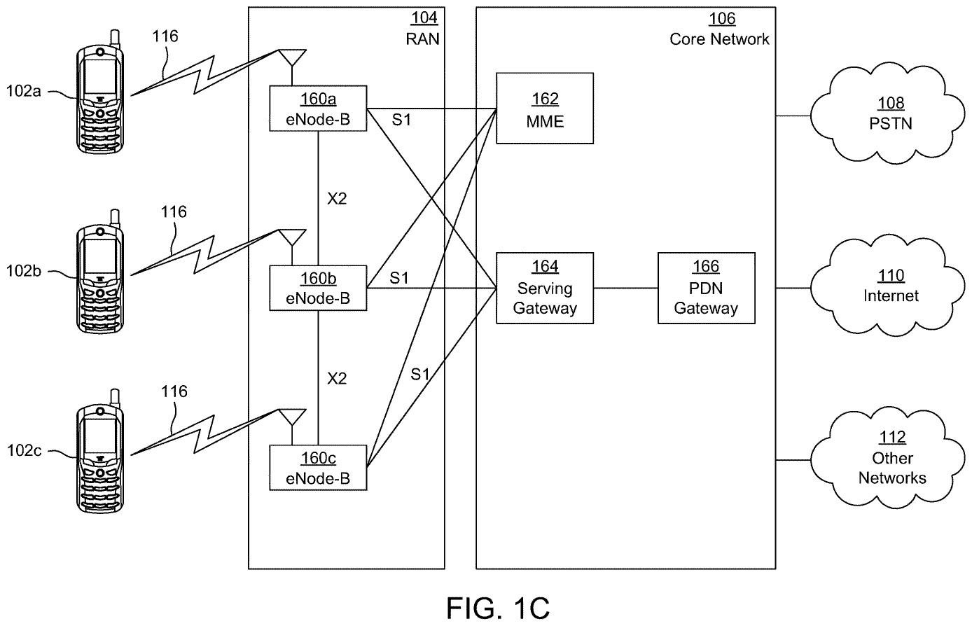

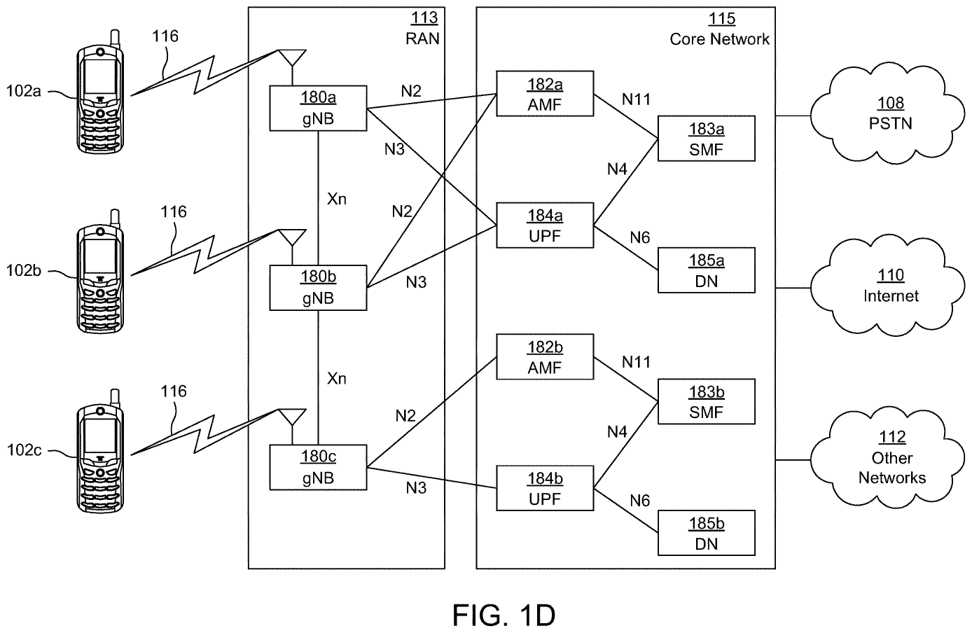

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (for example, associated with particular subframes for both the UL (for example, for transmission) and DL (for example, for reception) may be concurrent and/or simultaneous. The full duplex radio may include an interference management unit to reduce and or substantially eliminate self-interference via either hardware (for example, a choke) or signal processing via a processor (for example, a separate processor (not shown) or via processor 118). In an embodiment, the WTRU 102 may include a half-duplex radio for which transmission and reception of some or all of the signals (for example, associated with particular subframes for either the UL (for example, for transmission) or the DL (for example, for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (for example, 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC). 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (for example, containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (for example, handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering DL packets, providing mobility anchoring, and the like.

The CN 106 may facilitate communications with other networks. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

A Non-Public Network (NPN) is a Fifth Generation Mobile Telephone System (5GS) deployed for non-public use. An NPN may be either a Stand-alone Non-Public Network (SNPN) or a Public Network Integrated NPN (PNI-NPN). An SNPN is operated by an NPN operator and does not rely on network functions provided by a public land mobile network (PLMN). A PNI-NPN is a non-public network deployed with the support of a PLMN.

An NPN intended for the use of a private entity such as an enterprise, a factory, a warehouse, or the like. An SNPN can be identified by a combination of PLMN Identifier (ID) and Network ID (NID), where the PLMN ID may be, for example, reserved PLMN IDs for private networks, for example, with a Mobile Country Code=999.

The architecture of a 5G SNPN is based on the architecture of 5G Systems. The NG-RANs of the SNPN broadcasts the combination of PLMN IDs and NIDs. A WTRU operating in SNPN access mode reads the broadcast system information for the available SNPNs, such as PLMN IDs, NIDs, or both, and selects the SNPN for which it has subscription and credentials.

A PNI-NPN is a Non-Public Network made available using PLMN infrastructure/resources, for example, a PLMN network slice. A group of PLMN users which are allowed to access a certain PNI-NPN is referred to as a closed access group (CAG) and a CAG is identified by a CAG identifier. CAG users can only access a PNI-NPN from a cell that supports CAG access, which is called a “CAG cell”. A CAG cell broadcasts a list of CAG identifiers that it supports. A CAG WTRU is configured by the network with a list of CAGs that it can access (Allowed CAG List). When a CAG WTRU detects a CAG cell, it can only select/access the CAG cell if at least one of the broadcasted CAG identifier(s) matches one of the CAG identifiers in its Allowed CAG List.

In some circumstances, a small cellular network may be deployed to provide services to local users within a certain area. For example, a temporary non-public cellular network may be set up to provide a streaming video service to the audience in a live concert or a football match. For another example, in places like airports, shopping malls and school campuses, where a large crowd may gather, small cellular networks may be deployed to provide localized services, such as commercial ads in the shopping mall. The services provided by these small cellular networks have two basic characteristics: first, the services are localized, meaning that they are related to the activities/events in a certain spot or area, and are usually limited to the users within the area; and second, the users don't utilize these services on a regular basis but most likely in on-demand or temporary fashion.

3GPP is studying how to enhance 5G system to provide such localized services and enable users to access the hosting network that provides those services under one or more 3GPP Study Items. As used herein, those localized services may be referred to as “providing access to localized services (PALS) service” or “localized services,” and the network that provides PALS services are referred to as a “PALS network” or a “PALS hosting network” or simply a “hosting network.”

A hosting network may be an SNPN, a PNI-NPN, or a PLMN, in embodiments and examples provided herein. The local service provider may be the hosting network operator or a third party service provider.

Embodiments and examples provided herein address problems related to selection of the hosting network for accessing localized services. In examples, a WTRU may be enabled to discover, select and access an NPN as a hosting network and receive localized services.

Localized service information may be provided to the WTRU including one or any combination of the following information: validity conditions (duration, time and location), hosting network IDs, a list of prioritized hosting networks (for an SNPN case), or an allowed CAG list (for a CAG case). In examples, the localized service information may be provided to the WTRU via application data, external provisioning procedure, NAS signaling via new WTRU policy, and the like.

When the end user intends to access a localized service and the validity conditions of localized service are met, the WTRU may initiate hosting network selection using the hosting network selection information. Details of the hosting network selection procedure may be determined. When new network selection mode is required for WTRU to initiate hosting network selection may be determined. Details regarding priority list for hosting network selection, including if a new selection mode is required, may be determined.

Following are the questions and related problems which may be addressed with respect to search and selection of hosting network for accessing localized services. For example, how shall the WTRU perform the hosting network selection for specific localized service. If localized service is provided by both CAG cells and SNPNs, how does the WTRU prioritize one hosting network over the other. Further, if localized service is provided by both CAG cells and SNPNs, how are scenarios where search is not successful on one technology for example, CAG cells compared with SNPNs, handled. How does the WTRU handle the out of coverage scenario. For example, if the WTRU loses the coverage of the hosted network cell providing access to a certain localized service, how does the WTRU regain access to hosting network cell providing access to localized services. How does the WTRU handle Automatic and Manual hosting network selection modes. For example, how does the WTRU go about hosting network search and selection while operating in automatic or manual mode of operation.

The localized services are the services restricted by time and location and provided by hosting networks. A hosting network could be an SNPN, or a Public Network Integrated Non-Public Network (PNI-NPN), or a PLMN. The local service provider may be the hosting network operator or a third party service provider.

Embodiments and examples provided herein propose mechanisms and enhancements on how the end user/UE/WTRU would go about selecting hosting networks to get access to the localized services at a particular location. It further proposes how the automatic and manual hosting network selection could be optimized by defining new hosting network selection mode, 5GS assistance information, defining hosting network selection preference via universal subscriber identity module (USIM) elementary and the like.

Embodiments and examples provided herein may apply to one or more of enhanced non-public networks (eNPNs), SNPNs or PNI-NPNs (CAG) or the 5G core network 3GPP service and system aspects (SA)/core network and terminals (CT). Embodiments and examples provided herein include a new hosting network selection mode (HNSM) is defined for hosting network search and selection to gain access to localized services. Further, embodiments and examples provided herein include a new elementary USIM file, to provide preference for hosting network selection, such as CAG versus SNPN. In addition, embodiments and examples provided herein include a 5GS or credentials holder (CH) which provides hosting network selection preference information via NAS Signaling/User Plane.

Also, embodiments and examples provided herein include usage of the following to determine the hosting network selection preference between CAG or SNPN at power up, out of service (loss of coverage): a local non-volatile memory (NVM) storage/Power up sequence configuration/WTRU camped status, for example PLMN versus SNPN; and a last searched technology, for example, CAG versus SNPN hosting network. Moreover, embodiments and examples provided herein include cases where the hosting network search and selection is not successful (automatic mode), and the WTRU could start a back off timer, switch back to last WTRU mode and on expiry of this back off timer, return to hosting network selection mode and start with hosting network search and selection. Additionally, embodiments and examples provided herein include continuous or intermediate reporting of hosting networks during the manual hosting network selection mode.

Embodiments and examples provided herein include a hosting network selection mechanism, which include an automatic mode of operation. In an example, a WTRU may determine that it needs to access a localized service. This may occur when the WTRU receives a request for a localized service from a user for example. In examples, the request for a localized service may be generic or for a specific localized service identified by localized service identifier. Further, in examples, the request from a user may be from a WTRU hosted application, may be due validity conditions that are met for the hosting network availability for localized services, may be due to a periodic search for the hosting network if earlier searches were not successful, or a combination of these. Additionally or alternatively, the WTRU may determine that it needs to access a localized service when the WTRU loses coverage of the camped hosting network cell which was providing access to localized services.

Embodiments and examples provided herein may be used in a 3GPP access technology, such as NR 5G, NR 5G Advanced and the like. Additionally or alternatively, embodiments and examples provided herein may be used in one or more pro se networks or sidelink communications networks. Further, embodiments and examples provided herein may be used in non-3GPP access technologies such as WiFi. Moreover, embodiments and examples provided herein may be used to trigger a search for, to select, or both, any type of network providing localized services.

Further, the WTRU may enter the hosting network selection mode. If required, authorization is requested by the WTRU to the 5GC. In an example, authorization could be partial. For example, a set of hosting network services could be authorized by the 5GC. In a further example, authorization could be full. For example, the WTRU may be authorized to access full set of localized services. This authorization request may be seen in examples in figures included elsewhere herein.

The WTRU may trigger a search for the hosting network. The starting point for the search (for example, CAG or SNPN) may be based on one of the six proposed configuration methods as referenced in examples in figures included elsewhere herein. Further, the WTRU may start the search on CAGs or SNPNs. The decisions may be based on the outcome of a previous step. In an example, the search may be started with either CAG or SNPNs, and the WTRU may be configured with the CAGs which can provide access to localized services via an Allowed CAG List with validity conditions and SNPNs as hosting networks via a Credentials Holder controlled prioritized list of preferred SNPNs, and one or more group ID for network selections (GINs), which may be extended with, for each entry in the list, time validity information.

The result of the CAGs or SNPN search may be the identity of a CAG cell or an SNPN ID. The WTRU will then attempt to register with a network via the identified CAG cell or will attempt to register with the identified SNPN.

The hosting network selection preference could be provided by the home networks (home PLMN (HPLMN)/Subscribed SNPN), third (3^{rd}) party localized service providers, CH, or the visiting PLMN (VPLMN). This information could be provided via NAS signaling. In examples, this information may be provided via signaling related to a registration/WTRU configuration update, a WTRU parameter update, WTRU policy delivery procedures, Steering of Roaming, and the like. Additionally or alternatively, this information may be provided via an application layer over the user plane.

The WTRU could use other means to derive the preference and starting point for the hosting network search and selection. In examples, the WTRU could use, a user preference stored in NVM, a last searched technology (CAG versus SNPN), a power up sequence preference (if the WTRU employs a power up sequence), a WTRU camped status (PLMN versus SNPN), and the like.

Embodiments and examples provided herein include a hosting network selection mechanism, which include a manual mode of operation. In an example, a WTRU may determine that it needs to access a localized service. This may occur when the WTRU receives a manual request for a localized service (for a generic service or for a specific localized service identified by localized service identifier) from a user (for example a WTRU hosted Application).

The WTRU may enter the hosting network selection mode. If required, authorization may be requested by the WTRU from the 5GC. Authorization could be partial, in an example. In an example, a set of hosting network services could be authorized by the 5GC. In a further example, authorization could be full. For example, the WTRU may be authorized to access full set of localized services. This may be seen in examples shown in one or more figures included elsewhere herein.

The WTRU may trigger a search for the hosting network. The starting point for the search (for example, CAG or SNPN) may be based on one of the six proposed configuration methods, as seen in examples shown in one or more figures herein.

The result of the CAGs or SNPN search may be a report of available CAG or SNPN cells. The WTRU may report the found hosting networks to the user for selection by the user. The mobile terminal (MT) part of the WTRU may report the found networks to a WTRU hosted application. The reporting of the hosting network to the user could be continuous, for example, as and when hosting networks are found/detected. Additionally or alternatively, the WTRU may report the hosting networks after the search is complete on either or both access technologies (CAG and SNPN).

A new or modified USIM elementary file could include the hosting network selection preference, for example, CAG or SNPN, and this information could be linked with the localized service identifier. The hosting network selection preference could be provided by the home networks (HPLMN/Subscribed SNPN), third Party localized service providers, a CH, or the VPLMN. This information could be provided via NAS signaling. In examples, this information may be provided via signaling related to a registration/WTRU configuration update, a WTRU parameter update, WTRU policy delivery procedures, /Steering of Roaming, and the like. Additionally or alternatively, this information may be provided via the application layer over the user plane.

The WTRU could use other means to derive the preference and starting point for the hosting network search and selection. In examples, the WTRU could use a user preference stored in NVM, a last searched technology preferred (CAG versus SNPN), a power up sequence preference (if the WTRU employs a power up sequence), a WTRU camped status (PLMN versus SNPN), and the like.

Embodiments and examples provided herein following include a hosting network selection mechanism, which includes an automatic mode of operation. In an example scenario where the WTRU is operating in automatic mode for network selection, based on the criteria (time and location) the WTRU would switch to hosting network selection mode and select appropriate hosting network for providing the WTRU access to localized services.

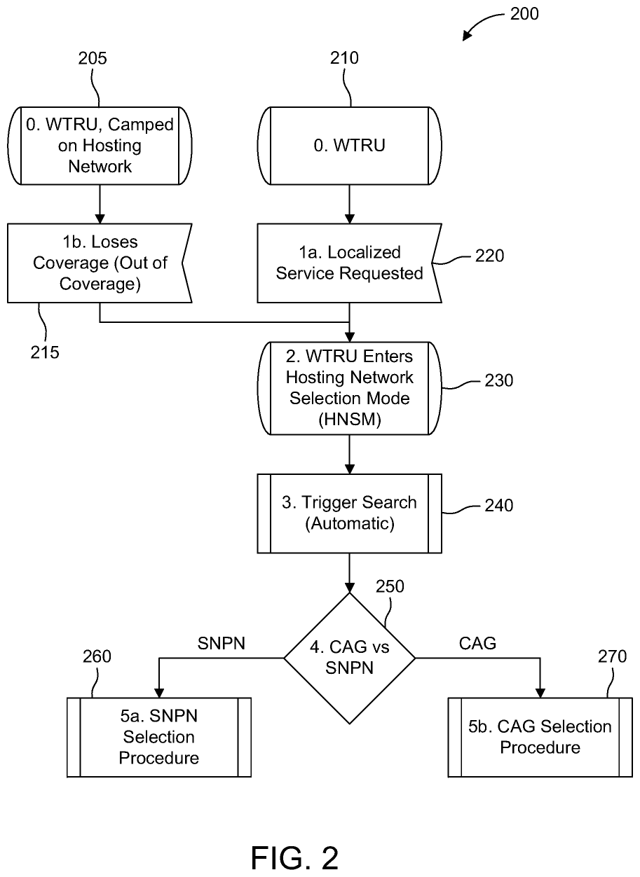

FIG. 2 is a flow chart diagram illustrating an example of an automatic mode of operation for hosting network selection. Examples shown in flow chart diagram 200 include hosting network selection for accessing localized services while a WTRU is operating in an automatic mode of network selection.

In Step 0 205, 210, the WTRU is operating in automatic network selection mode, camped successfully. In an example shown in block 205, the WTRU is camped on a hosting network cell. Additionally or alternatively, in an example shown in block 210, the WTRU is normal camped or limited camped on a PLMN cell.

In an example, the WTRU may have already been configured with localized service information. The configuration may have been done manually (for example, via a graphical user interface (GUI)) or the WTRU may have received the localized service information from the network (for example, in a NAS message). The MT part of the WTRU may use an attention (AT) Command to send the localized service information to an Application that is hosted in the terminal equipment (TE) part of the WTRU. The local service information may also include a localized service identifier (LS_ID), a service type, or both.

In a further example, at step 1a 220, the WTRU may process a request for a localized service. The WTRU may receive a request from a user for a localized service. Based on the criteria for time and location that is included in the localized service information, the MT part of the WTRU may receive a request for accessing one or more localized services from an application in the TE part of the WTRU, in an example. The request may be a generic request and not specific for a particular localized service.

In step 1b 215, another example scenario could be that the WTRU, which is already camped on a hosting network cell 205, loses coverage. The loss of coverage event 215 may be a trigger condition for the WTRU to look for the hosting network cell to get back in service and provide the WTRU with access to localized services, as described in more detail below.

In step 2 230, the WTRU enters the HNSM. The rationale behind entering this mode is that WTRU is now specifically looking for one or more hosting networks which could provide access to localized services. This step could be optional as well. Optionally entering the HNSM could be authorized by the home network (HPLMN) or subscribed SNPN, the authorization could be pre-configured (for example, in NVM/USIM file storage) by the home network (HPLMN or Subscribed SNPN) or could be obtained via exchange of information between the WTRU and the home network via NAS signaling. In examples, the NAS signaling may be one or more of steering of roaming (SoR), Registration/Configuration update command, and the like. In an example, home network authorization might be needed at this stage for the WTRU to trigger a hosting network selection procedure.

The WTRU may initiate an authorization procedure with the HPLMN or subscribed SNPN. The purpose of the procedure is to obtain authorization and a token from the HPLMN or subscribed SNPN to access the localized service. During the authorization process the network could update the list of allowed CAGs/, the prioritized list of SNPNs (along with validity conditions), or both. Further, this newly configured information may take precedence over the stored information with the WTRU.

In step 3 240, the WTRU may trigger a search. In examples, the trigger may be automatic. In an example, at this step, the WTRU may search for the hosting networks, as the hosting network could be an SNPN or PNI-NPN (CAG cells). Further, the WTRU may need to determine the starting point for the search. The triggering of the search and the starting point may be based on a configuration of the WTRU. Provided below are examples of criteria which could be used by the WTRU to determine the starting point for the hosting network search. Additionally or alternatively, the below example criteria may be used by the WTRU to determine whether to select a CAG or an SNPN.

In an example regarding a first criterion, which may be considered criterion 1, The WTRU may store a new elementary file in USIM, which could provide preferences for hosting network, for example, CAG compared with SNPN. Further, this information could be further indexed with the type of localized service (localized service ID). For example, for localized gaming service, usage of CAG cells is preferred over SNPNs. In a contrasting example, for IMS, SNPNs as the hosting networks providing access to localized services are preferred over CAG cells. The content of this elementary file may be based on CAG/SNPN preference information that is received from the network. The network could update the contents of this USIM elementary file via an over the air USIM application toolkit (USAT) REFRESH command. In examples, the USIM may be present for a CAG search.

In a further example regarding a second criterion, which may be considered criterion 2, the user could have its own preference which is configured via a GUI and stored locally in the NVM storage in the WTRU. Criterion 2 may be considered to be a user configuration criterion.

In another example involving a third criterion, which may be considered criterion 3, the choice of CAG or SNPN as the starting point may be based on the last searched technology, for example, CAG or SNPNs Hosting Networks. Specifically, the WTRU will start the search using the last searched technology. In an example scenario, the last access to a hosting network was via SNPNs, and a fresh new request will trigger the WTRU to look for SNPNs over CAG cells providing access to localized services.

In an additional example concerning a fourth criterion, which may be considered criterion 4, the preference, for example, CAG compared with SNPNs Hosting Networks, may automatically be configured after a power up sequence. This information could be either based on user preference or provided by the home networks (HPLMN/Subscribed SNPN), by third party localized service providers, or by both. Accordingly, this criterion may be considered to be a power up sequence preference.

In yet a further example regarding a fifth criterion, which may be considered criterion 5, the preference may be based on information that is provided by one or more of the home networks (for example, an HPLMN, a Subscribed SNPN or both), third Party localized service providers, a CH, or the VPLMN. This search preference information could be provided via NAS signaling. In examples, the NAS signaling may be one or more of registration signaling, a WTRU configuration update, a WTRU parameter update, WTRU policy delivery procedures, an SoR, and the like. In a further example, this preference information via application layer over user plane). Also, this preference information may be considered a preference value, in examples. Criterion 5 may be considered to be a search preference provided by HPLMN/VPLMN/CH criterion.

In yet another example involving a sixth criterion, which may be considered criterion 6,) the preference may be based on the WTRU's Camped Status, for example PLMN or SNPN. For example, the WTRU, which is already camped on SNPN, could search SNPN hosting networks before making the switch to CAG cells. Similarly, if the WTRU is camped on PLMN it would search for CAG cells before making the switch to SNPNs providing access to localized services.

The criteria used to determine the starting point for search could have associated priority and a higher priority setting would take precedence over the lower priority settings. In a specific example, criterion 2 may have a higher priority setting than criterion 5. Accordingly, criterion 2 may take precedence over criterion 5. Further, criterion 5 may have a higher priority setting than criterion 4. Accordingly, criterion 5 may take precedence over criterion 4. Also, criterion 4 may have a higher priority setting than criterion 1. Accordingly, criterion 4 may take precedence over criterion 1. In addition, criterion 1 may have a higher priority setting than criterion 3. Accordingly, criterion 1 may take precedence over criterion 3. In a further example, criterion 3 may have a higher priority setting than criterion 6. Accordingly, criterion 3 may take precedence over criterion 6.

In a further example considering the priorities defined in the above case, if criterion 2, the user configuration criterion, is not present in the WTRU, criterion 5, the search preference provided by HPLMN/VPLMN/CH criterion, would take the highest current precedence, because criterion 5 has the next highest precedence after criterion 2. Accordingly, the hosting network search starting point will be determined based on configured criterion 5, the search preference provided by HPLMN/VPLMN/CH criterion. The new priority order would be, for example, criterion 5, which is over criterion 4, which is over criterion 1, which is over criterion 3, which is over criterion 6, in order of precedence from highest to lowest.

In step 4 250, based on the outcome of the Step 3 240, the WTRU may make a decision to either start search from CAG (PNI-NPN) cells or start search from SNPN cells.

Once the decision is made as to which access technology, such as CAG or SNPN, the WTRU would search for hosting networks, then the WTRU may execute the search and selection procedure for the access technology. For example, if the WTRU decides that SNPN is the access technology, then the WTRU may execute an SNPN selection procedure at Step 5a 260, which may also include a procedure to search for an SNPN. Similarly, if the WTRU decides that CAG is the access technology, then the WTRU may execute a CAG selection procedure at Step 5b 270, which may also include a procedure to search for a CAG.

In an example, if in case the hosting network selection procedure for the access technology decided upon is not successful, the WTRU may fall back to the other access technology. For example, if at Step 4 250, the WTRU decided upon the SNPN access technology, the WTRU would proceed to step 5a 260 and execute an SNPN selection procedure. If the WTRU does not then successfully select an SNPN, the WTRU may then fall back to the CAG access technology, and may execute a CAG selection procedure.

Similarly, if at step 4 250, the WTRU decided upon the CAG access technology, the WTRU would proceed to step 5b 270 and execute a CAG selection procedure. If the WTRU does not then successfully select an CAG, the WTRU may then fall back to the SNPN access technology, and may execute an SNPN selection procedure.

In another example solution, the request to access localized service could be for specific localized service. In an example, accessing a specific or particular localized service may include access a gaming service, a video streaming service, and the like.

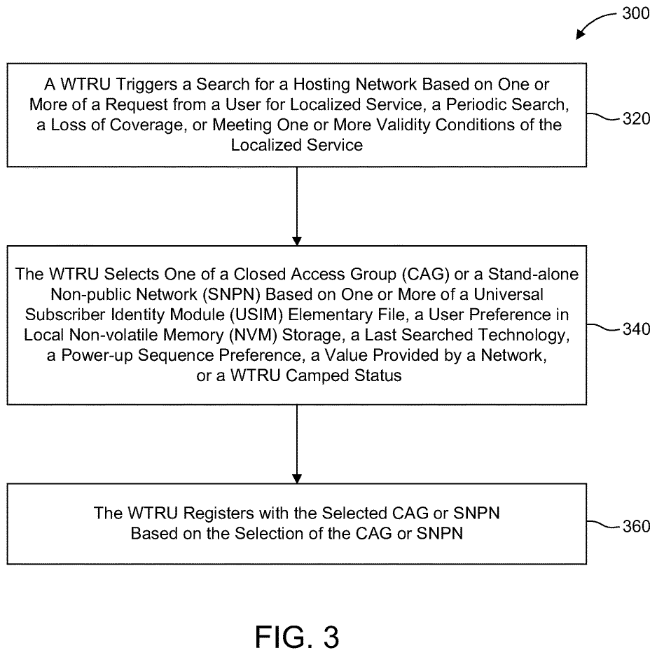

FIG. 3 is a flow chart diagram illustrating an example of a method of operation for hosting network selection. In an example shown in flow chart diagram 300, a WTRU may trigger a search for a hosting network based on one or more of a request from a user for localized service, a periodic search, a loss of coverage, or meeting one or more validity conditions of the localized service 320.

Further, the WTRU may select one of a CAG or an SNPN based on one or more of a USIM elementary file, a user preference in local NVM storage, a last searched technology, a power-up sequence preference, a value provided by a network, or a WTRU camped status 340. Accordingly, the WTRU may then register with the selected CAG or SNPN based on the selection of the CAG or SNPN 360.

In a further example, one or more of the USIM elementary file, the power-up sequence preference, or the value provided by the network may be received by the WTRU in configuration information. In an additional example, the network may be an HPLMN, a VPLMN, or a CH.

In a further example, one or more of the USIM elementary file, the user preference in local NVM storage, the last searched technology, or the power-up sequence preference, includes a preference for the CAG or the SNPN. In another example, the WTRU camped status may include a PLMN status or an SNPN status. Also, the loss of coverage may include an out of coverage scenario.

In an additional example, the user preference may be received by way of a manual request for localized services by a user. Moreover, a validity condition may include one or more of a time condition, a location condition or a duration condition, in an example.

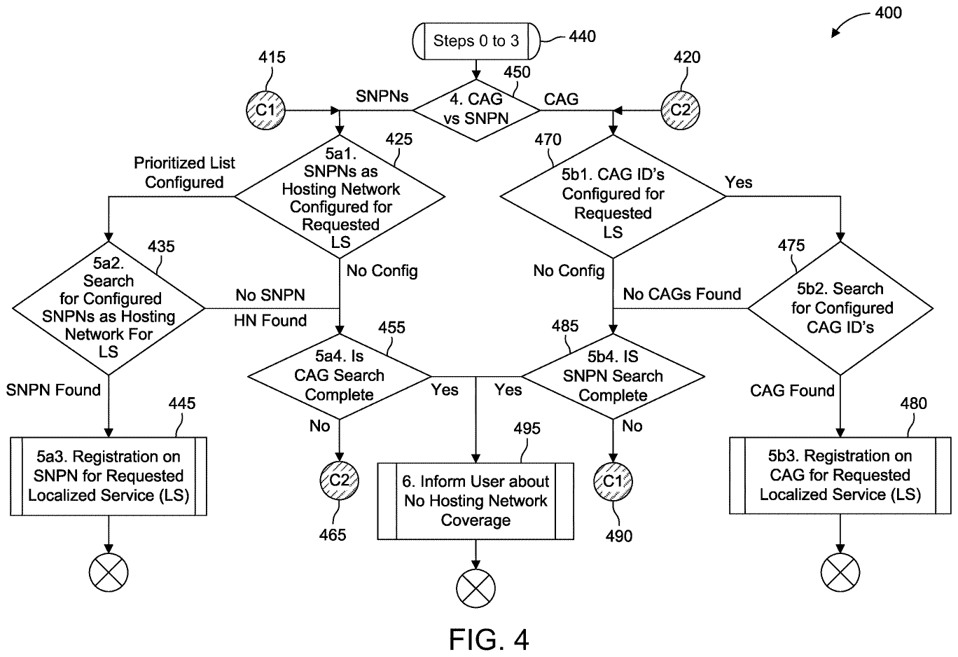

FIG. 4 is a flow chart diagram illustrating an example of a CAG and SNPN selection procedure. As shown in examples in flow chart diagram 400, step 5a, step 5b, or both, may be expanded from the CAG and SNPN selection procedure of FIG. 2. Further, in examples shown in FIG. 4, there may be a delta change to step 1a, as detailed following, and the rest of the flow of the step may remain the same.

In examples, step 1a may include: Based on the criteria of time and location that is included in the Localized service information, the MT part of the WTRU may receive a request for accessing specific localized services, for example, a localized service identifier, such as LS_ID_1 from an Application in the TE part of the WTRU. The localized services may include one or more of a gaming service, a streaming video service, and the like.

In examples shown in FIG. 4, steps 0-4 440, 450 may be the same as steps 0-4 205, 210, 215, 220, 230 240, 250 for examples shown in FIG. 2. Accordingly, the WTRU may be operating in automatic network selection mode. The examples shown in FIG. 4 may apply to an SNPN selection procedure, to a CAG selection procedure, or to both.

In an example, the WTRU may have selected 450 an SNPN or a CAG. This selection may have been made after also performing steps 0-3 440.

One or more of the following steps may be used in an SNPN selection procedure.

In step 5a1 425, an SNPN has been chosen by the WTRU as the starting point for hosting network selection 450, or step 5a1 425 is a follow up step after the WTRU has exhausted the search on CAG side for hosting network selection C1 415. The WTRU may first check is to ensure SNPNs are configured within the WTRU as hosting networks. For example, the WTRU may check if SNPNs are part of a prioritized list of hosting networks (SNPNs) that are available along with the validity conditions, such as time and location. In an example, the WTRU may determine if the hosting network is configured for a requested localized service (LS). A decision of “Prioritized list configured” as shown to the left of diamond 425 in FIG. 4 means the WTRU may search for configured hosting networks, as explained below for step 5a2 435. Or else if “no config” as shown below diamond 425, the WTRU may will check if a search is required on CAG side at step 5a4 455.

In step 5a2 435, a prioritized list of hosting networks (SNPNs) is configured in the WTRU, and the WTRU may search for available hosting networks (SNPNs) following their order as per the prioritized list. If the search is successful, the WTRU will move to the next step (step 5a3 445) of registration with the found SNPNs in priority order. Or else if no SNPNs are found, the WTRU will move to step 5a4 455.

In step 5a3 445 if a hosting network is found (such as an SNPN), the WTRU will trigger registration with the SNPN to access localized services. If registration is not successful, the WTRU will try to register on the next available SNPN as per their priority order and availability of the SNPNs (found during the search phase). In case registration is not successful on any of the found/available hosting networks, the WTRU may switch to CAG mode, and try to search and select available CAG cells which could provide access to localized services. In an example, the WTRU may switch to CAG mode by way of C2 465. Although the connection between 5a3 445 and C2 465 is not explicitly shown in the figure, one of skill in the art will understand that such a connection is possible and compatible with the examples provided herein.

In step 5a4 455, an input to this step may be from step 5a1 425, if the WTRU is not configured with prioritized list of hosting networks (SNPNs). Or an input to step 5a4 455 may be from step 5a2 435, if no SNPNs as a hosting network (HN) are found. At this point in step 5a4 455, the WTRU may check if a CAG search has been performed for accessing localized services. In case a CAG search has not been performed or is not complete, the WTRU may trigger a CAG search and selection procedure C2 465. Or else, if a CAG search has been performed or is complete, the WTRU may go to step 6 495, for example, and inform the user about the hosting network search and selection outcome (no hosting network coverage) and configure the WTRU for next actions, which are explained more fully regarding step 6 495 further below.

One or more of the following steps may be used in a CAG selection procedure.

In step 5b1 470, a CAG search and selection has been chosen by the WTRU as the starting point for hosting network selection 450, or step 5b1 470 is a follow up step after the WTRU has exhausted the search on the SNPN side for hosting network selection C2 420. The WTRU may first check to ensure CAG cells providing access to localized services are configured in the WTRU. For example, the WTRU may check if CAG cells are part of an allowed CAG list. In an example at step 5b1 470, the WTRU may determine if the CAG cells, based on the CAG IDs, are configured for a requested LS.

In case CAG cells are configured, the WTRU will move to the next step 5b2 475, and search for allowed CAG cells providing access to localized services, as explained further below. On other hand at step 5b1 470, if no CAG cells are configured, the WTRU will mark CAG search and selection as complete at step 485, and determined if the SNPN search is complete, as explained further below. The WTRU may the move to the next step C1 490, for example, and search SNPNs hosting network selection, starting at step C1 415, if it has not already been done.

In step 5b2 475, the WTRU may search for the configured CAG cells, for example, in part of or in at least part of the allowed CAG list, along with the validity conditions. For example, the WTRU will search for configured CAG IDs at step 5b2 475. If a CAG is found, the WTRU may move to step 5b3 480, which is explained below. If No CAGs are found, the WTRU may move to step 5b4 485, as explained further below.

In step 5b3 480, a CAG cell is found providing access to localized services, and the WTRU will try to register with the CAG/PLMN to get access to the localized services. If registration is not successful on CAG cells, the WTRU will switch to SNPN hosting network selection if it has not already been performed. In an example, the WTRU may switch to SNPN hosting network selection by way of C1 490. Although the connection between 5b3 480 and C1 490 is not explicitly shown in the figure, one of skill in the art will understand that such a connection is possible and compatible with the examples provided herein.

In step 5b4 485, an input to this step may be from 5b1 470, if no CAG cells are configured in the WTRU. Or an input to step 5b4 485 may be from step 5b2 475, if no CAG cells were found providing access to localized services. At this point the WTRU in step 5b4 485, the WTRU may check if SNPN search has been performed for accessing localized services. In case an SNPN search has not been performed or is not complete, the WTRU may trigger an SNPN search and selection procedure C1 490. Or else, if an SNPN search has been performed or is complete, the WTRU may go to the step 6 495, for example, and inform the user about the hosting network search and selection outcome (no hosting network coverage) and configure the WTRU for next actions, as explained in the following.

In step 6 495: the user is informed about the interim results (No hosting network coverage) and the following actions could be done by the WTRU operating in the Automatic mode. The WTRU may start a back off timer and at expiry of this timer, re-trigger the search procedure from beginning. Further, the WTRU may switch to last WTRU mode for example, a PLMN selection mode, or an SNPN access mode. Further, the WTRU may wait for the back off timer expiry, which will switch the mode back to the HNSM and trigger a hosting network search and selection procedure, which may be as shown in, for example, FIG. 2.

The WTRU at any point of time would exit from the HNSM if the user terminates access to localized services or any event within the WTRU moves the WTRU to PLMN selection/SNPN access mode, or a different mode.

Embodiments and examples provided herein following include a hosting network selection mechanism, which include a manual mode of operation. While the WTRU is camped normally on a cell, such as a normal cell or a hosting network cell, the WTRU could trigger the manual search for hosting networks availability in the camped area and could trigger selection of the desired hosting network.

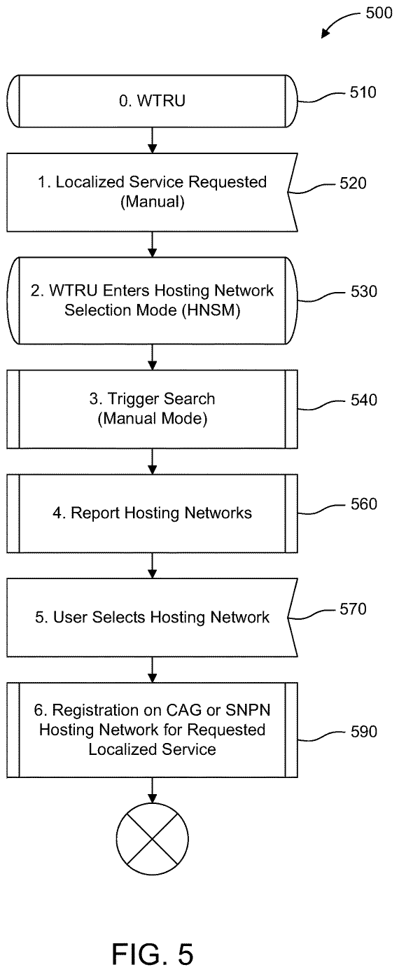

FIG. 5 is a flow chart diagram illustrating an example of a manual hosting network search and selection procedure. Examples shown in flow chart diagram 500 outline the flow for the manual mode hosting network search and selection procedure.

In step 0 510, the WTRU is camped on a cell, which may be a normal cell or a hosting network cell, with the cell providing normal or limited services. In examples, the WTRU may be operating in manual mode or in automatic mode.

In step 1 520, the user may request for a localized service search in manual mode. The user may use a GUI application that runs in the TE part of the WTRU to send the request to the MT part of the WTRU via an AT command. The TE part of the WTRU may respond with Localized service information that was previously configured in the WTRU and stored in the WTRU.

In step 2 530, the WTRU enters the HNSM. The rationale behind entering this mode is that WTRU is now specifically looking for hosting networks which could provide access to localized services. This step could be optional as well. Optionally entering the HNSM could be authorized by the home network (HPLMN) or subscribed SNPN, the authorization could be pre-configured (for example, by NVM/USIM file storage) by the home network (HPLMN or Subscribed SNPN) or could be obtained via exchange of information between the WTRU and the home network via NAS signaling. In examples, the NAS signaling may be an SoR, a Registration/Configuration update command, and the like. The WTRU may initiate an authorization procedure with the HPLMN or subscribed SNPN. The purpose of the procedure is to obtain authorization and a token from the HPLMN or subscribed SNPN to access the localized service. During the authorization process the network could update the list of allowed CAGs/prioritized list of SNPNs (along with validity conditions), and this newly configured information would take precedence over the stored information with the WTRU.

In step 3 540, the next step is for the WTRU to search for the hosting networks which could provide access to a specific localized service. In an example, the specific localized service may be identified via an LS_ID_1 (localized service identifier), in case Manual search was requested specifically for a specific localized service. In another example, the specific localized service could be for generic localized services. The hosting network could be an SNPN or PNI-NPN (CAG cells). Further, the WTRU may need to determine the starting point for the search. The WTRU may also give preference to either CAG cells or the SNPNs in the search. Below are few criteria which could be used by the WTRU to determine the starting point for the hosting network search. The WTRU may also use the criteria to give preference to the CAGs or the SNPNs.

In an example regarding a first criterion, which may be considered criterion1, the WTRU may store a new elementary file in USIM, which could provide preferences for hosting network, for example, a CAG or an SNPN. Further, this information could be further indexed with the type of localized service (using, for example, a localized service ID); for example, for localized gaming service, usage of CAG cells is preferred over SNPNs, while for IMS, SNPNs as the hosting networks providing access to localized services are preferred over CAG cells. The content of this elementary file may be based on CAG/SNPN preference information that is received from the network. The network could update the contents of this USIM file via an over the air USAT REFRESH command, in an example.

In another example regarding a second criterion, which may be considered criterion 2, the User could have their own preference which is configured via a GUI and stored locally in the WTRU. In an example, the user preference may be stored in the NVM in the WTRU.

In a further example regarding a third criterion, which may be considered criterion 3, the choice of CAG or SNPN as the starting point may be based on the last searched technology, for example, CAG or SNPN Hosting Networks. In an example, the WTRU will start the search using the last searched technology. In an example scenario, the last technology used to access to a hosting network was via SNPNs. Accordingly, a fresh new request will trigger the WTRU to look for SNPNs over CAG cells providing access to localized services.

In an additional example regarding a fourth criterion, which may be considered criterion 4, the preference, for example, for a CAG or SNPN, may always be configured after a power up sequence for the WTRU. This configuration information could be either based on user preference or provided by the home networks (HPLMN/Subscribed SNPN), by third party localized service providers, or by both.

In yet a further example regarding a fifth criterion, which may be considered criterion 5, the preference may be based on information that is provided by the home networks (HPLMN/Subscribed SNPN), by third Party localized service providers, by a CH, or by the VPLMN. This information could be provided via NAS signaling. For example, this information may be provided by one or any combination of a registration, a WTRU configuration update, a WTRU parameter update, WTRU policy delivery procedures, Steering of Roaming, and the like. Additionally or alternatively, this information may be provided via the application layer over the user plane.

In yet another example regarding a sixth criterion, which may be considered criterion 6,) the preference may be based on the WTRU's camped status, such as a PLMN camped status or an SNPN camped status. For example, the WTRU, which is already camped on an SNPN, may search for SNPN hosting networks before making the switch to CAG cells. Similarly if the WTRU is camped on a PLMN, the WTRU may search for CAG cells before making the switch to SNPNs for providing access to localized services.

The criteria used to determine the starting point for a search could have associated priority, and a higher priority setting would take precedence over the lower priority settings. For example, the order of precedence, from highest precedence to lowest precedence, among the criteria may be 2, then 5, then 4, then 1, then 3, then 6. In a specific example, criterion 2 may have a higher priority setting than criterion 5. Accordingly, criterion 2 may take precedence over criterion 5. Further, criterion 5 may have a higher priority setting than criterion 4. Accordingly, criterion 5 may take precedence over criterion 4. Also, criterion 4 may have a higher priority setting than criterion 1. Accordingly, criterion 4 may take precedence over criterion 1. In addition, criterion 1 may have a higher priority setting than criterion 3. Accordingly, criterion 1 may take precedence over criterion 3. In a further example, criterion 3 may have a higher priority setting than criterion 6. Accordingly, criterion 3 may take precedence over criterion 6.

In a further example, considering the priorities defined in the above case, if criterion bullet 2, the user configuration criterion is not present in the WTRU, then criterion 5, the search preference provided by HPLMN/VPLMN/CH criterion would take the highest current precedence, because criterion 5 has the next highest precedence after criterion 2. Accordingly, the hosting network search starting point will be determined based on configured criterion 5, the search preference provided by HPLMN/VPLMN/CH criterion. The new priority order among the criteria would be for example, 5, then 4, then 1, then 3, then 6, in order of precedence from highest to lowest.

In step 4 560, reporting of the hosting networks could be performed as follows, in an example. The WTRU may conduct continuous reporting as and when hosting networks are found, such as CAGs or SNPNs. Additionally or alternatively, the WTRU may report found CAG cells, SNPN hosting networks, or both, after the searches are complete on both technologies.

In step 5 570, the user may select one of the hosting network reported by the WTRU. In an example, the selection may be entered by the user into an application using a GUI.

In step 6 590, the WTRU may follow with the registration on the selected hosting network, such as CAG or SNPN. Further, the WTRU may inform the user about the results. For example, the WTRU may inform the user about success or failure to register on the user selected hosting network.

Although features and elements are described above in particular combinations, one of ordinary skill in the art will appreciate that each feature or element can be used alone or in any combination with the other features and elements. Further, one of ordinary skill in the art will appreciate that the features and elements described above include means for implementing the methods described herein. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, STA, AP, relay node, mesh node, customer premises equipment (CPE), fixed wireless access (FWA) device, industrial device, or any host computer.

1. A method for use in a wireless transmit/receive unit (WTRU), the method comprising:
triggering a search for a hosting network based on one or more of a request from a user for localized service, a periodic search, a loss of coverage, or meeting one or more validity conditions of the localized service;
selecting one of a closed access group (CAG) or a stand-alone non-public network (SNPN) based on one or more of a universal subscriber identity module (USIM) elementary file, a user preference in local non-volatile memory (NVM) storage, a last searched technology, a power-up sequence preference, a value provided by a network, or a WTRU camped status; and
registering with the selected CAG or SNPN based on the selection of the CAG or the SNPN.

2. The method of claim 1, wherein one or more of the USIM elementary file, the power-up sequence preference, or the value provided by the network are received in configuration information.

3. The method of claim 1, wherein the network is a home public land mobile network (PLMN) (HPLMN), a visiting PLMN (VPLMN), or a credential holder (CH).

4. The method of claim 1, wherein one or more of the USIM elementary file, the user preference in local NVM storage, the last searched technology, or the power-up sequence preference, includes a preference for the CAG or the SNPN.

5. The method of claim 1, wherein the WTRU camped status includes a PLMN status or an SNPN status.

6. The method of claim 1, wherein the loss of coverage includes an out of coverage scenario.

7. The method of claim 1, wherein the user preference is received by way of a manual request for localized service by a user.

8. The method of claim 1, wherein the one or more validity conditions include one or more of a time condition, a location condition or a duration condition.

9. A wireless transmit/receive unit (WTRU) comprising:
a processor; and
a transceiver, operatively coupled to the processor; wherein:
the processor and the transceiver are configured to trigger a search for a hosting network based on one or more of a request from a user for localized service, a periodic search, a loss of coverage, or meeting one or more validity conditions of the localized service;
the processor is configured to select one of a closed access group (CAG) or a stand-alone non-public network (SNPN) based on one or more of a universal subscriber identity module (USIM) elementary file, a user preference in local non-volatile memory (NVM) storage, a last searched technology, a power-up sequence preference, a value provided by a network, or a WTRU camped status; and
the processor and the transceiver are configured to register with the selected CAG or SNPN based on the selection of the CAG or the SNPN.

10. The WTRU of claim 9, wherein one or more of the USIM elementary file, the power-up sequence preference, or the value provided by the network are received in configuration information.

11. The WTRU of claim 9, wherein the network is a home public land mobile network (PLMN) (HPLMN), a visiting PLMN (VPLMN), or a credential holder (CH).

12. The WTRU of claim 9, wherein one or more of the USIM elementary file, the user preference in local NVM storage, the last searched technology, or the power-up sequence preference, includes a preference for the CAG or the SNPN.

13. The WTRU of claim 9, wherein the WTRU camped status includes a PLMN status or an SNPN status.

14. The WTRU of claim 9, wherein the loss of coverage includes an out of coverage scenario.

15. The WTRU of claim 9, wherein the user preference is received by way of a manual request for localized service by a user.

16. The WTRU of claim 9, wherein the one or more validity conditions include one or more of a time condition, a location condition or a duration condition.
